(19) United States
(12) Patent Application Publication
(10) Pub. No.: US 2021/0301408 A1
(43) Pub. Date: Sep. 30, 2021

(54) A Method for the Electrochemical Synthesis of Ammonia from Nitrates and Water

(71) Applicant: The Board of Trustees of the Leland Stanford Junior University, Stanford, CA (US)

(72) Inventors: Joshua M. McEnaney, East Palo Alto, CA (US); Adam Christopher Nielander, Menlo Park, CA (US); Sarah Jane Blair, Stanford, CA (US); John Schwalbe, Palo Alto, CA (US); Thomas Francisco Jaramillo, Menlo Park, CA (US)

(21) Appl. No.: 17/265,295

(22) PCT Filed: Jul. 31, 2019
(86) PCT No.: PCT/US2019/044504

§ 371 Date: Feb. 2, 2021

Related U.S. Application Data
(60) Provisional application No. 62/714,369, filed on Aug. 3, 2018.
(60) Provisional application No. 62/800,073, filed on Feb. 1, 2019.

(51) Int. Cl. C25B 1/27; B01J 21/06

(52) U.S. Cl. CPC C25B 1/27; B01J 21/063

(57) ABSTRACT

A method of ammonia production is provided that includes holding a nitrate source in an electrolyte solution, using a reaction chamber, reducing the nitrate into ammonia or ammonium, whereby producing water or hydroxide ions, using a cathode in the reaction chamber, oxidizing the water or hydroxide ions into protons and oxygen or water and oxygen, using an anode in the reaction chamber, and separating the ammonia and the ammonium from the reaction chamber, using an ammonia and ammonium output.

### FIELD OF THE INVENTION

The present invention relates generally to synthesizing NH₃. More particularly, the invention relates to synthesizing NH₃ by a different means, from water and nitrates, based on an electrochemical process with selective electrocatalysts such as titanium.

### BACKGROUND OF THE INVENTION

Ammonia (NH₃) is primarily used for fertilizer production and has promise as a molecule for chemical energy storage. NH₃ is one of the world's most important chemicals for sustaining a growing human population with a production rate at the global scale of over 100 million tons per year via the Haber-Bosch process. This process relies on fossil fuels, can only be done cost effectively in extremely large, centralized facilities, making NH3 distribution difficult.

Since the invention of the Haber-Bosch process, ammonia synthesis has become a vital process for producing fertilizer and sustaining the growing human population. Nitrogen as a nutrient in fertilizers is widely used in the form of ammonium nitrate, where both the ammonium and the nitrate ions are derived from Haber Bosch ammonia. In conventional production, the Haber Bosch process is used to produce ammonia which is then converted to nitric acid in the Ostwald process. Additional ammonia is then directly reacted with the nitric acid to produce ammonium nitrate. Unfortunately, the Haber Bosch process is energy and resource intensive, consuming over 1% of the global energy supply while producing more than 1% of all CO₂ emissions (over 450 million metric tons). As this process is carried out in only a few centralized facilities, the required global network of ammonia distribution results in additional CO₂ emissions. Furthermore, the Ostwald process releases N₂O, which is 298 times stronger as a greenhouse gas than CO₂, effectively constituting 1% of all non-CO₂ greenhouse gas emissions. Global utilization efficiency of nitrogen produced via these processes for crops averages to only about 50% of the applied nitrogen source, resulting in wasteful nitrate runoff in water from agricultural fields. These nitrates have significant detrimental effects on wildlife, particularly via eutrophication. Such contamination renders water sources unhealthy for human consumption, and nitrates have been linked to both methemoglobinemia in infants and increased risk for various types of cancer in adults. Due to these environmental and human health hazards, a significant amount of research has focused on electrochemical technologies for water remediation with the goal of reducing nitrates to harmless N₂, thus cleaning the water supply. Ammonia produced in these systems is often viewed as being counterproductive to the goal of water purification, and research is generally driven to minimize the quantity of ammonia that is produced. However, if ammonia or ammonium nitrate were selectively produced from a nitrate source and subsequently isolated, not only could the water be purified, but the nitrate could be recycled into a useful chemical commodity while mitigating the need for energy-intensive and unsustainable Haber-Bosch ammonia.

Selective nitrate reduction to ammonia is a fundamentally difficult process. Thermodynamically, there are many possible products that can be formed from nitrates and water at similar reduction potentials (Including NO₂[0.77 V vs RHE], NO₂⁻[0.94 V], NO [0.96 V], N₂O [1.12 V], N₂ [1.25 V], NH₂OH [0.73 V], N₂H₄[0.82 V], NH₃[0.88 V]). It is also kinetically challenging as it comprises an eight-electron reduction, transforming a fully oxidized, negatively charged polyatomic ion to a fully reduced molecule on a cathode surface. Additionally, the concentration of negatively charged species is typically assumed to be very low near the surface of negatively biased electrodes, further hampering the reduction rate. Despite these challenges, electrochemical water remediation for nitrate removal has advanced significantly toward the selective formation of benign N₂. As a result, such studies have also detected a range of products which have been reported across a variety of catalyst and electrochemical conditions. Such products include ammonia, hydroxylamine, nitrite, nitrous oxide, and hydrazine reported for a wide variety of cathodes, including Sn, Bi, Al, Pb, Ni, Cu, Ti, SiC, graphite, as well as bimetallic and alloy materials, all in the context of maximizing selectivity to nitrogen gas. Additional reports have shown differences in alternative product selectivity based on changes in electrode material and pH applied.

What is needed is a method for ammonia production using electrolyte and catalyst engineering

### SUMMARY OF THE INVENTION

To address the needs in the art, a method of ammonia production is provided that includes holding a nitrate source in an electrolyte solution, using a reaction chamber, reducing the nitrate into ammonia or ammonium, whereby producing water or hydroxide ions, using a cathode in the reaction chamber, oxidizing the water or hydroxide ions into protons and oxygen or water and oxygen, using an anode in the reaction chamber, and separating the ammonia and the ammonium from the reaction chamber, using an ammonia and ammonium output.

In one aspect of the invention, the cathode is separated from the anode using a diffusion barrier or membrane.

In another aspect of the invention, the nitrate source can include KNO₃, NaNO₃, LiNO₃, HNO₃, or a mixture of nitrates.

According to one aspect of the invention, the nitrate source is an aqueous or non-aqueous electrolyte solution.

In a further aspect of the invention, the cathode can include Ti, steel, Zn, Al, Ga, Pb, Co, Ta, Fe, Ni, Mo, Re, titanium alloys, or metal compounds.

In yet another aspect of the invention, the anode can include graphite, steel, Ni, Pt, IrO₂, or metal alloys.

According to one aspect of the invention, the nitrate source is replaced by NₓO_{y} species that can include NO₂, NO₂⁺, N₂O, NO, NO⁻, or a mixture of NₓO_{y} species.

In one aspect of the invention, the electrolyte solution includes a solvent such as water, propylene carbonate, tetrahydrofuran, acetonitrile, ethanol, an acid, a base, non-aqueous polar solvents, ionic liquids, or molten salts

In a further aspect of the invention, the electrolyte solution includes an electrolyte such as nitric acid, nitrous acid, inorganic nitrate compounds, NₓO_{y} charged species, protons, hydroxides, or salt additives. In one aspect, the nitrate compounds can include KNO₃, NaNO₃, LiNO₃, Ca(NO₃)₂, and Fe(NO₃)₂.

In another aspect of the invention, the reaction chamber includes a stack of alternating electrodes and cathodes.

### BRIEF DESCRIPTION OF THE DRAWINGS

FIG. 1 shows and example reaction chamber configured to hold a nitrate source in an aqueous or non-aqueous electrolyte with possibly other additives, according to embodiments of the invention.

FIGS. 2-4 show alternative embodiments of the example reaction chamber of FIG. 1. There is an input for fresh nitrate source when the nitrate is consumed in this process. Ammonia may be produced from a proton source such as H₂O, H₂, or another source of H.

FIG. 5 shows a schematic diagram of ammonium nitrate synthesis from waste nitrates cycle, according to one embodiment of the invention.

FIG. 6 shows heatmap plots at 4 distinct pH values showing Faradaic efficiency to NH₃ by varying applied potentials and nitrate concentrations, where each grid block represents a 30 min chronoamperometry, performed at the indicated (quadrant subtitle) pH, in the given (Y-axis) nitrate concentration electrolyte, and held at the indicated (X-Axis) potential. The inset, transparent white circles scale linearly in size with the logarithm of the partial current density toward ammonia under each corresponding set of conditions on the grid, up to a maximum observed current density of ˜59 mA/cm², according to the current invention.

FIGS. 7A-7C show (7A) combination plot depicting results on a Ti working electrode using a Nafion membrane divider and a Pt counter electrode with a 0.3 M KNO₃ and 0.1 M HNO₃ electrolyte at distinct applied working electrode potentials (X). Total current density (TCD) of the cell (Y1 scatter-line plot black), partial current density (PCD) toward ammonia (Y1 scatter-line plot gray), and Faradaic efficiency (Y2 bar graph) results are shown. (7B) Chronoamperometric plot resulting from a potential hold at −1 V vs RHE using the Ti/Nafion/Pt/cell configuration and replacing the 0.3 M KNO₃ and 0.1 M HNO₃ electrolyte every 2 h for an 8 h period. (7C) Representative X-ray diffractogram showing a Ti/TiHₓ working electrode before and after electrochemical testing in acidic, nitrate media, according to the current invention.

FIG. 8 shows preliminary technoeconomic analysis considering only the electricity cost required to produce ammonium nitrate from N₃⁻ based on a given price of electricity, cell efficiency, and total cell potential applied. The brown region shows USDA data for the cost of ammonium nitrate from 2004-2014, with the average cost per metric ton in this period as an inset brown dashed line.

### DETAILED DESCRIPTION

Nitrates from agricultural run-off are a notorious waste product and hazardous pollutant that must be removed to provide tap water that is safe for consumption. While traditional electrochemical water remediation approaches aim to solve this problem by converting nitrates to environmentally benign N₂, the current invention provides a method to turn these waste nitrates into ammonia, a commodity product. The electrochemical conversion of nitrates to ammonia and other useful nitrogen-based products recycles the previously fixed nitrogen and offers an appealing and supplementary alternative to the energy- and resource-intensive Haber-Bosch process. Provided herein are an outline of the engineering electrochemical conditions (pH, nitrate concentration, applied potential) to map out the selectivity trends of nitrate reduction to ammonia at a titanium cathode. This reaction depends strongly on applied electrolyte conditions, resulting in a wide range of values for selectivity and partial current density to ammonia. At peak selectivity performance conditions, it is shown that there is a 78% Faradaic efficiency to ammonia at an applied potential of −1 V vs RHE and operating current of 23 mA/cm². Using strong acid and ˜0.4 M [NO₃⁻], it is further shown that this peak performance is due to the high availability of both protons and nitrate ions, allowing selectivity to be directed toward ammonia production. The Ti electrocatalyst itself, as a poor hydrogen evolution catalyst with a significantly negative point of zero charge and notable corrosion resistance, also allows for the achievement of a high selectivity in the reduction of nitrates anions. In one example, stability of the system was evaluated, resulting in a high Faradaic efficiency (>50%) maintained during the course of an 8 hour experiment. After electrochemical testing, titanium hydride was observed at the cathode surface. Provided herein is a preliminary technoeconomic study showing that it is feasible to employ an electrochemical strategy for the production of ammonium nitrate.

As the world population grows and resources remain limited, a prosperous future is increasingly dependent on the development of new technological pathways and advancements toward sustainable processes. The current invention provides a sustainable strategy in which an environmental pollutant and industrial waste product, nitrates, can be electrochemically transformed into ammonia, a useful and vital chemical commodity. This transformation could offset the use of Haber-Bosch ammonia production, which is historically dependent on expensive high pressure, centralized infrastructure, and unsustainable fossil fuel use. The key advancement in of the current invention is the explicit targeting of electrochemical ammonia production from nitrates to achieve over 75% electrochemical selectivity toward NH₃. Such advances in product selectivity enable the continued development of commercial electrochemical processes, which offer a pathway toward decreasing carbon emissions as they are amenable to coupling with renewable electricity.

The current invention provides a system and method to synthesize NH₃ by a different means, from water and nitrates (a water contaminant), based on an electrochemical process with selective electrocatalysts such as titanium. Titanium is provided as an electrocatalyst for this reaction capable of achieving over 80% faradaic efficiency toward ammonia.

The current invention is useful for localized production of ammonia and/or ammonium nitrate production for farmland fertilization via this electrocatalytic process. The invention has further applications for systems requiring energy to be stored, e.g. storing variable energy sources such as renewable electricity (wind, solar, etc.) in the form of chemicals, e.g. NH₃. The invention is also useful for production of precursor chemicals to many nitrogen containing chemicals and materials, and ammonia production as a fuel alternative or hydrogen storage medium.

The Haber-Bosch ammonia synthesis requires over 1% of the entire global energy supply and 3-5% of the natural gas supply for pre-requisite hydrogen production. The current invention uses water rather than molecular hydrogen as a source of atomic hydrogen and may thus mitigate these resource demands. In one aspect, the invention may also operate at significantly lower pressures than the Haber-Bosch which may lower equipment and operational costs as well as allowing for localized production of ammonia (mitigated distribution costs). In another aspect, the nitrogen utilization efficiency from Haber-Bosch ammonia synthesis is poor, as it requires large-scale centralized facilities that poses challenges for distribution, as such only approximately 50% of the produced NH₃ is taken up by crops in the fertilized agricultural fields. With local production and implementation, ammonia solutions may be directly applied to crops for fertilization, which may increase nitrogen utilization efficiencies, as well as mitigate cost of fertilizer production. In yet another aspect, the nitrate runoff from farms may be captured and reconverted into ammonia or ammonium nitrate to decrease both costs and detrimental environmental impact. There are significantly lower CO₂ emissions from this process when coupled to renewable electricity, as opposed to the conventional Haber-Bosch ammonia process which is dependent on fossil fuels. According to one aspect, other water remediation technologies aim to produce N₂ as a harmless but worthless product, while we aim to take nitrate waste streams and make marketable ammonia based products.

An example reaction chamber holds a nitrate source such as KNO₃, NaNO₃, LiNO₃, HNO₃, or a mixture of nitrates in an aqueous or non-aqueous (i.e. water, propylene carbonate, tetrahydrofuran, acetonitrile, ethanol, an acid, a base, non-aqueous polar solvents, ionic liquids, and molten salts) electrolyte with possibly other additives (i.e. acid, base, or chemical additive to shift the selectivity of the final products under desired conditions). This chamber may possess a cathode such as titanium suitable for nitrate reduction (i.e. Ti, steel, Zn, Al, Ga, Pb, Co, Ta, Fe, Ni, Mo, Re, titanium alloys, and metal compounds) and an anode suitable for oxidation of hydroxide ions to water and oxygen (or water to oxygen) (i.e. graphite, steel, Ni, Pt, IrO₂, and metal alloys). These electrodes may be solid or porous materials and may be integrated with supporting materials to aid in their functionality (i.e. material additives to shift selectivity of nitrogenous species to make ammonia or ammonium). Produced ammonia may be separated as a product itself or may be collected as ammonium nitrate or ammonium hydroxide after synthesis.

The electrochemical process involves the electrochemical reduction of nitrate sources to produce ammonia or ammonium in an electrolyte solution. This process may vary depending on the chemicals, materials, and conditions chosen, and may start from the nitrate or other nitrogen containing chemicals in solution as a result of nitrate presence or controlled decomposition (ex NO₂ or NO₂⁻).

Nitrate reduction will generally take place at the cathode of the electrochemical cell and one of several species may be oxidized at the anode (i.e. H₂O, H₂, NH₃), with the default being water oxidation. The following are 2 series of the example reactions for this process:

Series 1:

KNO₃+2H₂O→NH₃+2O_{2(g)}+[Overall Reaction] Equation 1

NO₃⁻+6H₂O+8e⁻→NH₃+[Cathode] Equation 2

8OH⁻→4H₂O+2O_{2(g)}+8e⁻[Anode] Equation 3

The second series shows example chemical reactions in acidic electrolyte (Equations 4-6).

Series 2:

HNO₃+H₂O→NH₃+[Overall Reaction ] Equation 4

NO₃⁻+9H⁺+8e⁻→NH₃ [Cathode] Equation 5

4H₂O→8H⁺+2O₂+8e⁻[Anode]Equation 6

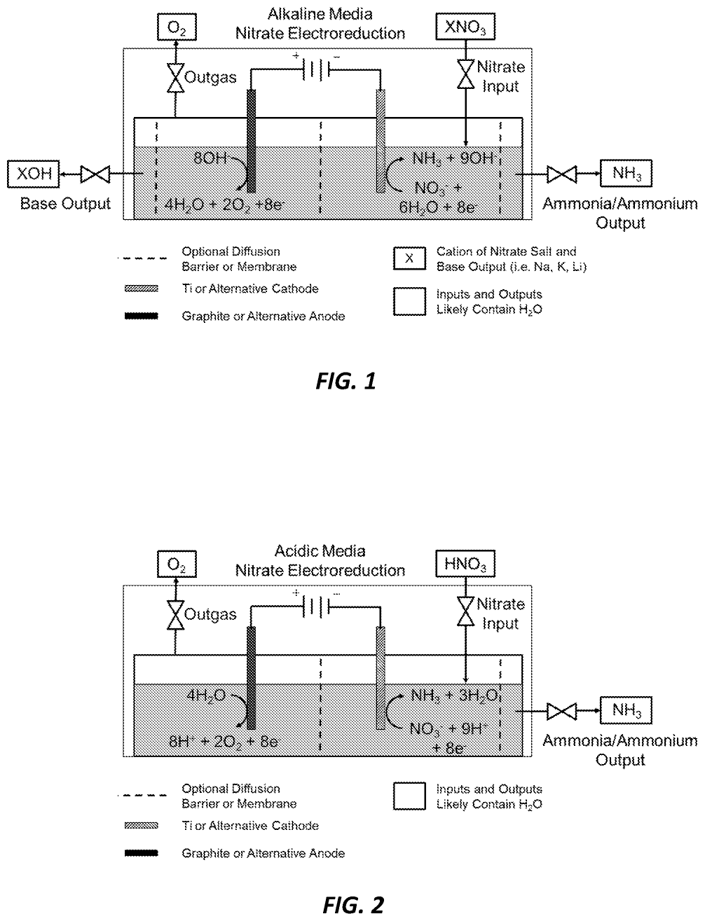

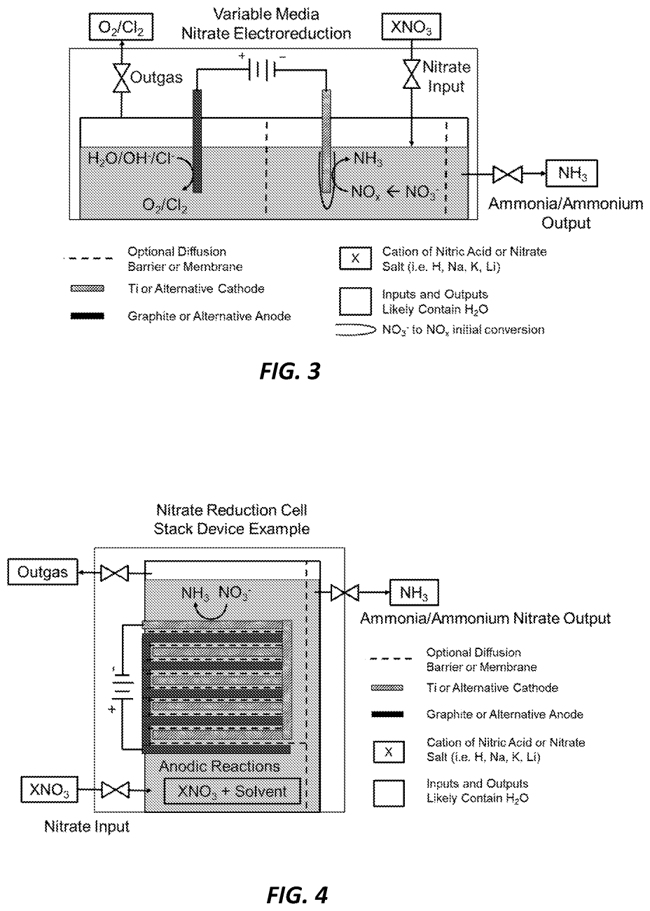

An example electro-thermochemical apparatus is described generally by the following description with example illustrations shown as appended drawings. The descriptions and illustrations provided depict only representative embodiments of the invention and are therefore not to be limiting of its scope. An example reaction chamber (FIG. 1) may hold a nitrate source such KNO₃, NaNO₃, LiNO₃, HNO₃, or a mixture of nitrates in an aqueous or non-aqueous (i.e. water, propylene carbonate, tetrahydrofuran, acetonitrile, ethanol, an acid, a base, non-aqueous polar solvents, ionic liquids, and molten salts) electrolyte with possibly other additives (i.e. acid, base, or chemical additive to shift the selectivity of the final products under desired conditions). This chamber may possess a cathode such as titanium suitable for nitrate reduction (i.e. Ti, steel, Zn, Al, Ga, Pb, Co, Ta, Fe, Ni, Mo, Re, titanium alloys, and metal compounds) and an anode suitable for oxidation of hydroxide ions to water and oxygen (or water to oxygen) (i.e. graphite, steel, Ni, Pt, IrO₂, and metal alloys). These electrodes may be solid or porous materials and may be integrated with supporting materials to aid in their functionality (i.e. material additives to shift selectivity of nitrogenous species to make ammonia or ammonium). Produced ammonia may be separated as a product itself or may be collected as ammonium nitrate or ammonium hydroxide after synthesis. FIGS. 2-4 show potential alternative manifestations of this process in a device. There is an input for fresh nitrate source when the nitrate is consumed in this process. Ammonia may be produced from a proton source such as H₂O, H₂, or another source of H.

To explore and direct selectivity, an appropriate, versatile electrocatalytic material should be chosen. Several cathode materials including Ti, steel, Zn, Al, Ga, Pb, Co, Ta, Fe, Ni, Mo, Re, titanium alloys, and metal compounds are presented herein. Titanium is an earth abundant, inexpensive metal that is often used as a relatively inert support material for electrodes in electrocatalysis. This indicates that it will have a large electrochemical potential stability window to explore with a reasonable tolerance for moderate applied potentials in aqueous electrolytes. It is also known as a robust metal with excellent corrosion resistance to acidic, basic, and high salinity solution conditions. Thus, titanium is a preferred cathode for an exemplary embodiment.

Provided herein, titanium is highly selective for ammonia production via electroreduction of nitrates. Presented herein is an evaluation of the effect of pH, nitrate concentration, and applied potential on the selectivity and electrochemical activity of titanium toward ammonia. General trends indicate that strongly acidic pH conditions (pH 0.77) and moderate to high nitrate concentration (˜0.1 to 0.6 M NO₃⁻) promote the highest selectivity toward ammonia synthesis. The favorable nitrate reduction properties of the Ti catalyst itself combined with electrolyte engineering to give a high availability of nitrate ions and protons promote selectivity to NH₃. Under optimized electrolyte conditions for selectivity, a Faradaic efficiency of 78% at a working electrode potential of −1 V vs RHE and operating current of ˜23 mA/cm² is provided, and it is noted that even higher current densities can be achieved while remaining highly selective for ammonia production.

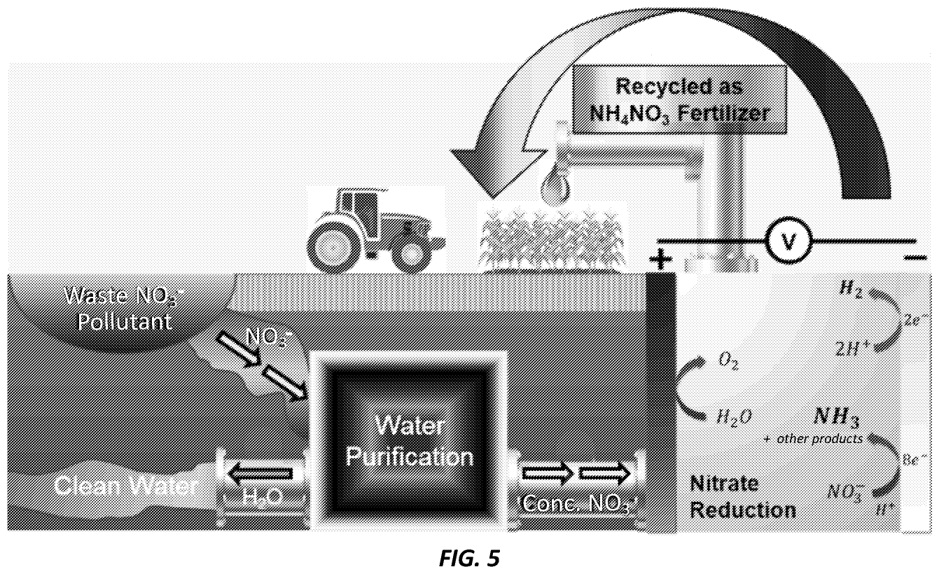

Nitrate reduction to ammonia could be coupled with water remediation technologies or used directly for commercial nitrate waste conversion to produce fertilizers or fuels if performed efficiently and cost effectively. In FIG. 5, shows an example nitrate recycling process to produce ammonium nitrate fertilizer, according to the current invention. Waste nitrate salts pollute fresh water resources as they flow from farmlands and must be captured and removed via a water purification process such as membrane reverse osmosis (RO), electrodialysis reversal (EDR), bacterial denitrification, electrochemical water remediation, or electrocapacitive ion capture. Several of these technologies have already been implemented to produce purified tap water, including RO and EDR, without utilizing the nitrate waste, while electrocapacitive ion capture is under development with an opportunity for selective nitrate capture and removal. Each of these three purification processes can be used to create a local or centralized concentrated nitrate source that can then be electrochemically reduced to ammonia, thus forming an ammonium nitrate product. The ammonium nitrate is subsequently recycled to the farmland as a common fertilizer. Additionally, more concentrated sources of nitrates may be found in uranium purification and processing byproducts, saltpeter mines, and directly in farmland irrigation runoff rather than the more dilute downstream water. While such nitrate salts with various cations have been employed as fertilizers, many are avoided due to the detrimental effect of sodium, calcium, or other ion buildup on the soil over time. The hydroxide forms of these cations can increase soil alkalinity, and some insoluble carbonate species can damage the soil quality, decreasing crop yield. Thus, converting nitrate salts to NH₄NO₃ is desirable as a reliable fertilizer. The nitrate reduction reaction can be divided into its two half-cell reactions depending on the proton source and pH of the electrolyte:

In acidic electrolytes, from protons:

Total Cell: KNO₃+2H₂O→NH₃+2O₂+KOH

Cathode: NO₃⁻+9H⁺+8e⁻→NH₃+3H₂O

Anode: 5H₂O→2O₂+9H⁺+8e⁻+OH⁻

In alkaline electrolytes, from water:

Total cell: KNO₃+2H₂O→NH₃+2O₂+KOH

Cathode: NO₃⁻+6H₂O+8e⁻→NH₃+9OH⁻

Anode: 8OH⁻→2O₂+4H₂O+8e⁻

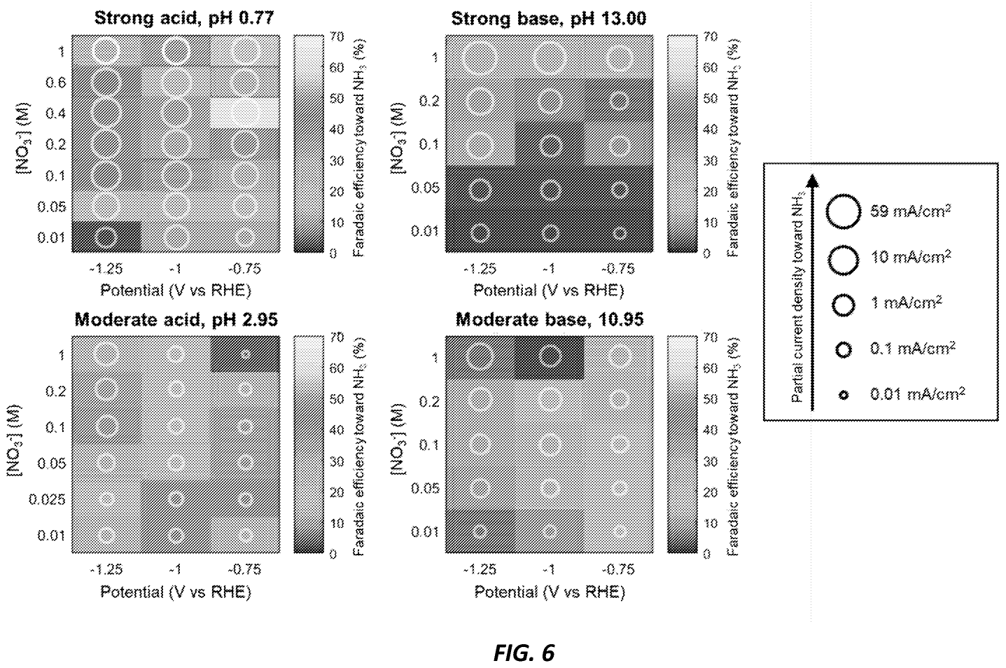

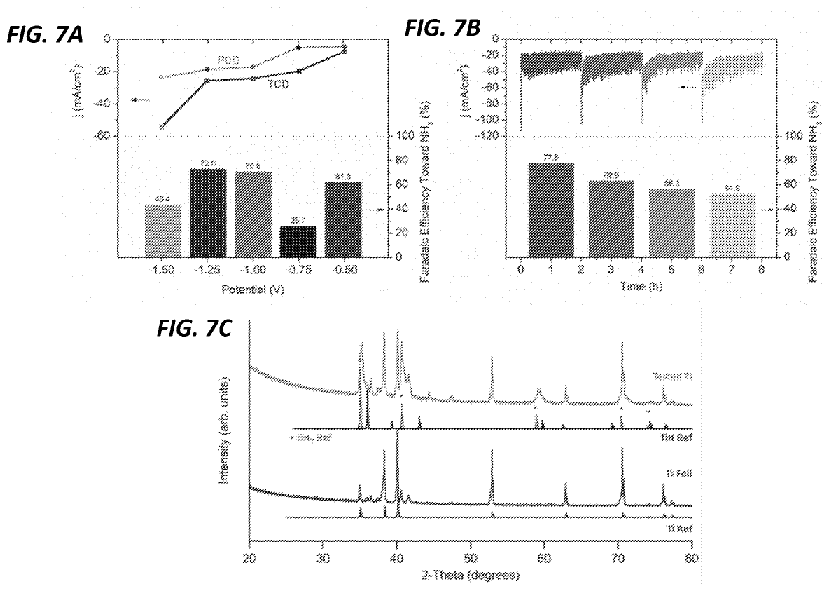

In order to understand and evaluate the reduction of nitrate to ammonia on a titanium electrocatalyst, a matrix of electrolyte conditions controlling pH was applied, nitrate concentration, and applied potential (FIG. 7). Cyclic voltammetry was used for the initial evaluation of the general electrochemical behavior of this system. Using a parallel-plate electrochemical cell equipped with a Ti working electrode, a glassy carbon counter electrode, and an Ag/AgCl reference electrode, (Ti/GC system) potential sweeps from 0 to −2 V vs RHE were performed at each of four pH values (˜0.77, 2.95, 10.05, and 13.00) in 0.1 M NO₃⁻ electrolytes. The resulting I-V curves show that electrolytes of more extreme pH values give significantly higher total current densities than those of moderate pH, with the highest currents exhibited by the strongly alkaline electrolyte (pH 13.00) at more negative potentials, despite equal ion concentrations across solutions. Under acidic conditions, mass transport limited electrochemical behavior was observed up to approx. −1.1 V vs RHE in the exemplary system, which are assigned to limited transport of H⁺ to the electrode surface. Potentials of interest were chosen based on the I-V behavior observed in the polarization data, and the full grid of electrolyte conditions was used to construct a heatmap of selectivity for ammonia synthesis, as shown in FIG. 6. Nitrate concentrations were adjusted with KNO₃, and pH was controlled by using HNO₃ and KOH at the desired proton or hydroxide concentration. Several interesting trends emerged from these data. First, it is observed that increased proton concentration generally corresponds to higher Faradaic efficiency toward NH₃, as both acidic solutions reach higher FE values than the basic solutions. In moderate base and moderate acid we generally observed peaks in Faradaic efficiency at moderate nitrate concentrations (between 0.25 M and 0.2 M NO₃⁻). Finally, an expanded set of electrolyte conditions were probed in strong acid considering that our standard 0.2 M and 1 M nitrate concentrations showed notably high selectivity toward ammonia. As a result, this region of expanded strong acid conditions surrounding ˜0.4 M NO₃⁻ shows an exceptionally high FE, approaching 70% of the current going toward ammonia. This high selectivity on a Ti electrode was feasible for several reasons. First, the most favorable electrolyte solutions had a high availability of proton and nitrate ions, allowing selectivity to be driven toward ammonia. Other related NₓO_{y} species such as NO₂ or NO₂⁺ in equilibrium with nitrate may also be present for reduction to ammonia depending on the pH and electrolyte solution contents. Further, among transition metals, titanium has been observed to possess a particularly negative point of zero charge, (reported as −1.05 V vs SHE in 0.1 N H₂SO₄,); thus, titanium may not repel nitrate ions as strongly as other cathode materials. Finally, in order to make an efficient process, ammonia production must outcompete hydrogen production at the potentials applied. Titanium is known as a poor hydrogen evolution reaction (HER) electrocatalyst, requiring a significantly higher overpotential than many other metals for the HER thus Ti has a large electrochemical window for alternative aqueous electrochemical reduction reactions.

Among the best performing set of conditions in the heatmap grid of experiments (FIG. 6) for both Faradaic efficiency and partial current density to ammonia were those at a nitrate concentration of 0.4 M in strong acid. To further improve these two metrics, a second set of experiments were run using a Nafion membrane divider and a platinum counter electrode in our electrochemical cell (Ti/Nafion/Pt setup), rather than the membrane-less cell and glassy carbon counter electrode (Ti/GC setup) of the heatmap experiments. The Nafion membrane was employed as a physical barrier to inhibit the crossover of the ammonia product, which may otherwise be oxidized at the counter electrode. Platinum is a preferred choice as a standard counter electrode as a significantly more active and stable oxygen evolution catalyst compared to glassy carbon. However, as platinum is also known to be an exceptionally good HER catalyst, it is essential to mitigate Pt crossover and deposition on the cathode. Fortunately, the Nafion membrane inhibits this process, which would otherwise result in an unstable increase in H₂ production if Pt deposits on the cathode. Although, it is important to note that Nafion is known to be problematic for ammonia detection at low concentrations due to ammonia contamination and triggering of the colorimetric test used to quantify NH₃ yields. Therefore, both a glassy carbon counter electrode and a cell without a Nafion membrane were chosen to avoid contamination in the heatmap experiments, despite the likelihood of lower efficiency and activity metrics.

As shown in FIG. 7A, higher Faradaic efficiencies and higher partial current densities toward NH₃ were observed in the Ti/Nafion/Pt system across the range of potentials tested when compared with the Ti/GC experimental setup used for the heatmap. Faradaic efficiency varied significantly depending on the potential applied, with a relative peak in efficiency near −1 to −1.25 V. The partial current density to NH₃ consistently increased with increasingly negative potentials.

The stability of the best performing region was studied using a series of 2 h, chronoamperometric experiments on a single Ti electrode, as shown in FIG. 3B. 0.1 M HNO₃/0.3 M KNO₃ electrolyte was replaced every two hours for the 8 h experiment, yielding an initial Faradaic efficiency of 78% toward ammonia for the first 2 h period. Faradaic efficiency decreases somewhat for each subsequent 2 h experiment but decreases less with each test, indicating that selectivity may be stabilizing over time. FE also remains above 50% throughout the test.

The state of the Ti electrocatalyst was also studied after significant electrochemical testing. Interestingly, in the chronoamperometric data for −1 V and −1.25 V samples with relatively low current, such as those in moderate acid, a significant current peak was observed during the first 10 min of reaction time (of the 30 min experiments). Repeating an above experiment using the same electrode under the same conditions with fresh electrolyte results in a more stable current, with no initial peak. Using X-ray diffraction, Ti foil cathodes were evaluated before and after electrochemical testing at −1 V in a series of moderate acid electrolytes and observed titanium hydride in the bulk material of the post-electrochemical testing sample (FIG. 7C). The hydride is also formed at sufficiently negative potentials for other pH values, though in most cases the higher current at these pHs is substantially greater than the hydride formation current. No significant hydride formation by XRD was observed when applying only −0.75 V vs RHE in moderate acid. Faradaic efficiency toward NH₃ improved somewhat by pre-treating the Ti electrode at strongly negative potentials to form the hydride such that current would not be directed toward the hydride formation in the moderate acid conditions. These results and the stability test of FIG. 7B, collectively indicate that the presence of TiHₓ does not drastically change the high catalytic capability of the electrocatalyst for the selective nitrate reduction reaction to ammonia.

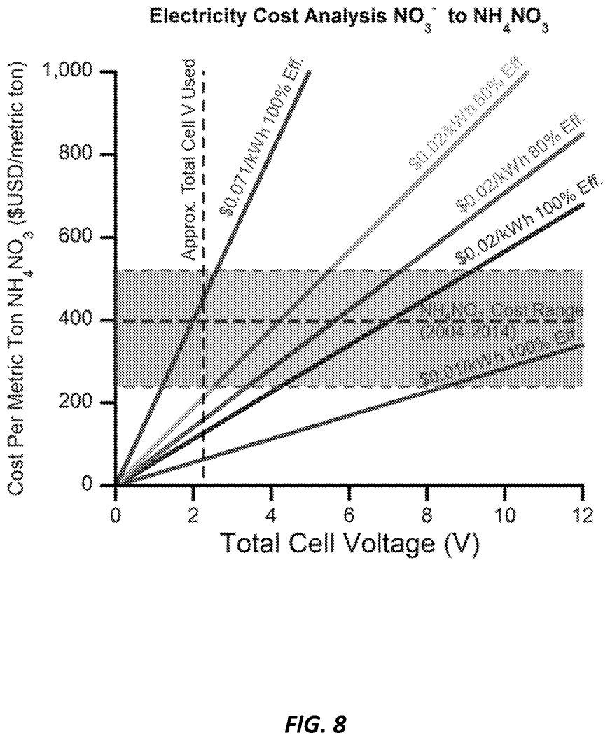

Considering that renewable energy is relatively inexpensive, is projected to continue to decrease in cost, and will likely become the cheapest source of electricity in many places and most countries within the next few decades, it is important to develop new opportunities for sustainable electrochemical technologies. To begin to evaluate the viability of ammonia production from nitrates, a preliminary technoeconomic analysis was performed, calculating the electricity cost of this electrochemical reaction at select costs of electricity. As shown in FIG. 8, the electricity cost per metric ton of NH₄NO₃ as a function of total cell potential was considered. By considering NH₄NO₃ as the final product, rather than NH₃, only half as much waste nitrate must be converted to ammonia, significantly improving the economic outlook. The vertical dashed line is the approximate total cell voltage applied in this study showing that with low electricity costs and reasonable Faradaic efficiencies, there is a significant opportunity to produce this fertilizer within or below the typical USDA tabulated cost range of NH₄NO₃, shown in brown. Note, the capital costs, nitrate supply costs, upkeep, separation and concentration costs, amongst others, will need to be taken into account to evaluate true viability; however, it is important to show that, despite an eight-electron reduction process, the reasonable electricity cost requirement of this reaction encourages further exploration.

Turning now to the experimental details. Regarding the chemicals and materials, titanium foil [99.7%, 0.25 mm, Sigma-Aldrich], glassy carbon foil [3000° C. Foil, 1.0 mm, Goodfellow Cambridge Limited (Aldrich)], platinum foil [99.997%, 0.1 mm, Alfa Aesar], nitric acid [69.6%, HNO₃ in water, Fisher Chemical], potassium nitrate [≥99.0%, KNO₃, Sigma-Aldrich], DI Millipore water, sodium hydroxide [99.99%, Sigma-Aldrich], sodium salicylate [99.5%, Sigma Life Science], sodium nitroprusside dihydrate [≥99%, Na₂[Fe(CN)₅NO]·2H₂O, Sigma-Aldrich], sodium hypochlorite solution [4.00-4.99%, NaOCl in water, Sigma-Aldrich], ammonium chloride [99.6%, NH₄Cl, Fisher Scientific], argon gas [Ultra-high purity, 99.999%, Praxair].

For the Electrochemical nitrate reduction testing method, electrochemical measurements were performed in a modified version of our previously reported flow cell, and were acquired using a Biologic SA model VMP3 potentiostat. In this flow cell, a three-electrode configuration was used, consisting of a titanium foil working electrode, a glassy carbon plate counter electrode, and an Ag/AgCl Accumet commercial reference electrode. The exposed Ti foil had a working electrode area of 0.3 cm² based on the O-ring seal in the cell. This limited the total current and ensured that the temperature of the electrolyte would not increase significantly over the course of the reaction. All electrochemical experiments were recorded using 85% IR compensation based on the ohmic resistance obtained (˜10-100 Ohms depending on salt concentration) via high frequency impedance testing. In a typical electrochemical test, 18 mL of the chosen electrolyte would be added to the flow cell, which was ambiently mixed by bubbling UHP argon gas through the cell at a rate of 20 SCCM. IR-compensated cyclic voltammetry was performed between 0 and −2 V vs RHE at a sweep rate of 10 mV/s and a nitrate concentration of 0.1 M for their respective pH value. Polarization data were recorded in the forward direction from 0 to −2 V.

For the heatmap of electrolyte conditions study (FIG. 6 results), chronoamperometry was performed with a single potential held constant (between −0.5 and −2 V vs RHE) for 30 min per test. Electrolyte was collected after each test for ammonia quantification and the cell was rinsed thoroughly with Millipore H₂O before fresh electrolyte was added. The same Ti electrode was used consecutively for one constant potential while changing nitrate concentrations across a heatmap column. After all nitrate concentrations were tested at that potential, the Ti foil was replaced, and the next potential was tested. Exact electrolyte conditions are summarized as follows: For strong acid, 0.1 M acid was always used, with pH verified (near 0.77) by a calibrated Accumet AB15 Fisher Scientific pH meter. HNO₃ was used when possible as an NO₃⁻ source and supplemented with KNO₃ increase nitrate concentration at the same pH. For the low nitrate concentrations in strong acid, HClO₄ was substituted in for HNO₃ to maintain pH. For moderate acid (pH 2.93) 0.001 M HNO₃ was used, with the desired amount of KNO₃ added. For moderate base (pH 10.95) and strong base (13.00) 0.001 M KOH and 0.1 M KOH were used, respectively, with KNO₃ again added to control nitrate concentration.

For the Ti/Nafion/Pt cell setup, the electrolyte solution used was 0.1 M HNO₃ and 0.3 M KNO₃ for a total nitrate concentration of 0.4 M. The cell was equipped with a Nafion 212 membrane (Fuel Cell Store 50 μm thick) with 20 SCCM UHP argon gas flowing through both the cathode (Ti) and anode (Pt) sides of the cell. After testing, the electrolyte from both sides of the cell were combined and tested as a whole for ammonia yield, quantified via a UV-Vis colorimetric test. The specific chemical signal for ammonia was verified across several conditions and tests with NMR, consistently showing the characteristic 1:1:1 triplet at 6.95 ppm in water.

Ammonia was detected using the indophenol blue test. For the test, 1 M NaOH was added to 1 mL of the used electrolyte solution until a pH of 12 was reached, after which 122 μL of sodium salicylate, 24 μL of sodium nitroprusside, and 40 μL of sodium hypochlorite were sequentially added and manually stirred together. The solution was then covered and left for 40 minutes, after which an Agilent Cary UV-Vis spectrometer was used to obtain spectra between wavelengths of 800 nm to 400 nm. Indophenol is known to absorb at approximately 650 nm; therefore, the indophenol peak was obtained by locating the maximum absorbance between 600 nm and 700 nm. In the event that the electrolyte solution contained too much ammonia and consequently saturated the detector, the UV-Vis test solution was remade, diluting the used electrolyte by factors of 10 until an absorbance readable by the detector was obtained. A UV-Vis calibration curve was created using known NH₄Cl solutions of known concentration up to approximately 5 ppm (using 17.03 g/mol for NH₃) to obtain a molar extinction coefficient that was then used in the Beer-Lambert law to calculate the concentration of NH₃ within the electrolyte for all subsequent electrolyte solutions. The electrolyte itself with no electrochemical testing was prepared with the same indophenol blue test to subtract any trace background contamination from the sample spectra and calibration curve. Disposable BRAND GMBH+CO KG cuvettes with a path length of 1 cm were used for calibration and experimental spectra.

Faradaic efficiency was calculated via the following equation:

$$F E ( \% ) = \frac{Charge ( C ) required to form [ {NH}_{3} ] found in electrolyte}{Total charge ( C ) passed during chronoamperometry} \times 100$$

where the total charge passed during chronoamperometry was calculated by integrating the chronoamperometric current over the duration of the experiment, and the charge required to form the amount of ammonia in the electrolyte was calculated using the fact that 8 electrons are required to form one molecule of ammonia from one molecule of nitrate.

For the physical characterization, ultraviolet-visible (UV-Vis) spectroscopy was performed using an Agilent Cary 6000i UV/Vis/NIR Spectrometer in absorbance mode across 1 cm path length BRAND GMBH+CO KG cuvettes, measured between wavelengths of 400 to 800 nm. X-ray diffraction (XRD) was performed using a Philips PANalytical X'Pert Pro in parallel beam mode with Cu Ka radiation and 0.04 rad Soller slits. X-ray Diffraction characterization was performed at the Stanford Nano Shared Facilities (SNSF). NMR analysis was performed on an Avance II Bruker NMR spectrometer operating at 900 MHz and at 25° C. except where noted. The instrument was equipped with a TCI cryoprobe and 16-sample sample changer. A previously reported echo sequence consisting of a hard 90° pulse followed by a gradient—selective 180—gradient echo pulse sequence was employed to maximize the quality of the NH₄⁺ signal.^{x}

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1) A method of ammonia production, comprising:
a) holding a nitrate source in an electrolyte solution, using a reaction chamber;
b) reducing said nitrate into ammonia or ammonium, wherein producing water or hydroxide ions, using a cathode in said reaction chamber;
c) oxidizing said water or hydroxide ions into protons and oxygen or water and oxygen, using an anode in said reaction chamber; and
d) separating said ammonia and said ammonium from said reaction chamber, using an ammonia and ammonium output.

2) The method according to claim 1, wherein said cathode is separated from said anode using a diffusion barrier or membrane.

3) The method according to claim 1, wherein said nitrate source is selected from the group consisting of KNO₃, NaNO₃, LiNO₃, Ca(NO₃)₂, Fe(NO₃)₂, HNO₃, or a mixture of nitrates.

4) The method according to claim 1, wherein said nitrate source is in an aqueous or non-aqueous electrolyte solution.

5) The method according to claim 1, wherein said cathode comprises a material selected from the group consisting of Ti, steel, Zn, Al, Ga, Pb, Co, Ta, Fe, Ni, Mo, Re, titanium alloys, and metal compounds.

6) The method according to claim 1, wherein said anode comprises a material selected from the group consisting of graphite, steel, Ni, Pt, IrO₂, and metal alloys.

7) The method according to claim 1, wherein said nitrate source is replaced by NₓO_{y} species from the group consisting of NO₂, NO₂⁺, NO₂⁻N₂O, NO, NO⁻, or a mixture of NₓO_{y} species.

8) The method according to claim 1, wherein said electrolyte solution comprises a solvent selected from the group consisting of water, propylene carbonate, tetrahydrofuran, acetonitrile, ethanol, an acid, a base, non-aqueous polar solvents, ionic liquids, and molten salts

9) The method according to claim 1, wherein said electrolyte solution comprises an electrolyte selected from the group consisting of nitric acid, nitrous acid, metal nitrate compounds, NₓO_{y} charged species, protons, hydroxides, and salt additives.

10) The method according to claim 1, wherein said reaction chamber comprises a stack of alternating electrodes and cathodes.
